(19) United States
(12) Patent Application Publication
(10) Pub. No.: US 2010/0014493 A1
(43) Pub. Date: Jan. 21, 2010

(54) NETWORK FOR WIRELESS DATA TRANSMISSION

(76) Inventors: Josef Brandstetter, Wien (AT); Diyap Canbolant, Wien (AT); Stefan Gross, Dettenheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/310,036

(22) PCT Filed: Jul. 27, 2007
(86) PCT No.: PCT/EP2007/057793

§ 371 Date: May 20, 2009

(30) Foreign Application Priority Data
Aug. 9, 2006 (DE) 10 2006 037 243.3

(51) Int. Cl. H04W 4/00

(52) U.S. Cl. 370/338

(57) ABSTRACT

A wireless data transmission network, the mode of operation of which is determined by a protocol stack according to the OSI reference model in addition to existing standards, is disclosed. In order to enable application-specific modifications during the transmission of data without having to dispense with or infringe upon the respective standard, an interoperability layer is inserted in the protocol stack between the security layer that follows the bit transmission layer and the additional protocol layers based thereon. The additional protocol layers are based on the interoperability layer with, for example, various interfaces in parallel individual stacks.

### CROSS REFERENCE TO RELATED APPLICATIONS

This application is the US National Stage of International Application No. PCT/EP2007/057793 filed Jul. 27, 2007 and claims the benefit thereof. The International Application claims the benefits of German application No. 10 2006 037 243.3 DE filed Aug. 9, 2006, both of the applications are incorporated by reference herein in their entirety.

### FIELD OF INVENTION

The invention relates to a wireless data transmission network, the mode of operation of which is determined by means of a protocol stack according to the OSI reference model. The invention further relates to a network subscriber for such a network and a method for wireless transmission of data in such a network.

### BACKGROUND OF INVENTION

The OSI reference model consists of seven protocol layers.

The lowest bit transmission layer (physical layer) provides mechanical, electrical and other functional aids, in order to activate or deactivate, and maintain, physical connections and to transmit bits via the connections.

The task of the next higher security layer (data link layer) is to guarantee a secure, i.e. fault-free, transmission and to control access to the transmission medium. According to IEEE, the security layer is divided into two part layers, i.e. a logic link control layer and a media access control layer, with the latter controlling the competing access of network subscribers to a transmission medium.

The tasks of the following network layer include the construction and updating of routing tables and also flow control. The network addresses also belong to this layer. Because a communication network can consist of several subnetworks with different technologies, the conversion functions, necessary for forwarding between the subnetworks, are also embedded in this layer.

The next higher layer (transport layer) offers a uniform access to the application-oriented layers up to the uppermost application layer that are based thereon, so that these properties of the communication network do not have to be taken account of.

Because of their simplicity, energy efficiency and cost effectiveness, radio networks based on the IEEE 802.15.4 standard are very attractive for wireless transmission of data in industrial automated technology, home and building automation and in many other applications. The ZigBee protocol from the ZigBee Alliance, which is a worldwide alliance of companies that work together to develop a reliable, cost-effective and cableless network of monitoring and control products based on an international open standard, was also based on this standard.

The IEEE 802.15.4/ZigBee standard is comprehensively described in a plurality of publications, and therefore the details of the standard are assumed to be known and are not dealt with in further detail here. The following publications are given as examples:

Michael Bürge: “Standards for wireless transmission: From Bluetooth to IEEE 802.15.4/Zigbee” [in German], ETH Zurich—Departement Informatik, Seminar on Distributed systems on the Topic of Smart Environments, SS 2004, found on the Internet on Jul. 14, 2006 under

http://www.vs.inf.ethz.ch/edu/SS204/DS/reports/09_zigbee_report.pdf,

Rudi Latuske: “Zigbee—Protocol software and development environment” [in German], September 2004, found on the Internet on Jul. 14, 2006 under

http://www.ars2000.com/ZigBee-White-Paper.pdf, or

Prof. Dr. Axel Sikora: “Short-Range Wireless Networking with IEEE 802.15.4 and ZigBee: Opportunities and Challenges” [in German], Design & Elektronik Entwicklerforum, Munich Jun. 7, 2004, found on the Internet on Jul. 14, 2006 under

http://www.stzedn.de/uploads/media/stz_zigbee_de_entwicklerforum_{—}040706.pdf.

Based on the OSI reference model, the IEEE 802.15.4 standard defines only the bit transmission layer and the media access control layer located above it. Although they are referred to in the standard, functions which relate to security in the media access control layer area are, however, transferred to the higher layers.

### SUMMARY OF INVENTION

Expert opinion considers that ZigBee cannot meet all the requirements of the industrial environment, so that it is considered useful to make certain modifications to the ZigBee protocol stack. This, however, contradicts the conformity of the available or agreed ZigBee protocol stack.

An object of the invention is therefore, in addition to existing standards, such as the IEEE 802.15.4/ZigBee standard, to enable application-specific modifications during data transmission without having to dispense with or infringe the respective standard.

According to the invention, the object is achieved in that an interoperability layer, on which further protocol layers can be based in parallel in individual stacks, is inserted between the security layer following the bit transmission layer and the other protocol layers based thereon. The interoperability layer enables an individual stack of the higher layers to be logically linked in each case to a stack of the lower layers.

Interoperability layers between different applications and a common communication infrastructure are generally known, but not in the inventive structure.

The bit transmission layer (physical layer) and security layer (data link layer) of the protocol stack can, for example, be defined by the IEEE 802.15.4 standard, by an IEEE 802.15.4 standard expanded by special functions for industrial requirements or by an alternative standard. The individual stacks are then based on the media access control layer. Other protocols, such as Dust Networks, Millennial Net or Zensys can also be used as individual stacks.

The insertion of the additional interoperability layer creates a terminated interface with dedicated access points to the protocol layers located below and thus enables various communication protocols in the protocol layers located above to be used either simultaneously or as required. The interoperability layer diverts the requirements, for instance a requirement to send a data package, and accesses to the higher layers, pre-process these in a format independent of a platform and supplies them to the layers located below. These can be realized on a proprietary hardware, so that the interoperability layer is then distributed to various hardware subsystems.

A transport layer, which enables a media access control layer to be connected to a host switching layer (network layer), is defined as part of the interoperability layer. The transport layer thus provides mechanisms which enable this connection to be established via a MAC hardware interface. In particular, it is the task of the transport layer to forward service primitives of a higher layer to the assigned media access control layer. Furthermore, general mechanisms, which, for example, enable a dynamic configuration of one or more protocol stacks, can be provided in the transport layer. Examples of these are as follows:

A search mechanism which enables a management application to determine which variants of the media access control layer are available. A specific higher layer can then be assigned to a specific lower layer corresponding to this information. This assignment can be changed at any time.

A flow control mechanism which enables the available bandwidth of the hardware interface to be distributed as required to parallel-running protocol stacks.

The transport layer therefore enables the network layer to be independent of the MAC hardware (module or chip-specific) below it, of the MAC hardware interfaces (e.g. UART, SPI, USB) and of the physical layers (radio technology, frequency, modulation processes) used. Accordingly, MAC subsystems can be realized independently of the network layer.

The introduction of the transport layer enables the more or less monolithic architecture of the respective protocol stack, as is the case with protocols presently on the market, such as ZigBee, to be omitted or bypassed and an alternative, or even parallel operation of a variety of protocol stacks to be achieved on one and the same target hardware.

### BRIEF DESCRIPTION OF THE DRAWINGS

A more detailed explanation of the invention is given in the following with reference to drawings. The drawings are as follows:

FIG. 1 An example of the inventive network, and

FIG. 2 The protocol stack of the network.

### DETAILED DESCRIPTION OF INVENTION

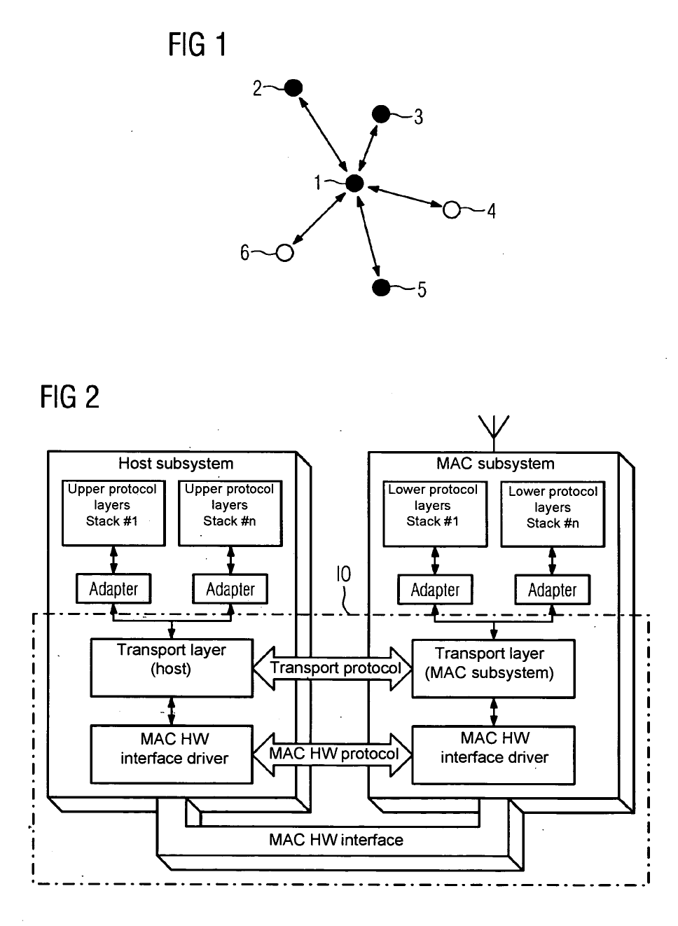

As an example of the inventive network FIG. 1 shows a ZigBee network whose topology can be constructed as a star network, or also as a tree or mesh network. The individual network nodes 1 to 6, in this case, consist of devices 1, 2, 3, 5 with full functionality (full-function devices=FFDs) and devices 4, 6 with a reduced functionality (reduced-function devices=RFDs). In this case, devices 1 to 6 each perform one of the following roles: network coordinator, alternative coordinator, router or terminal. Each role can also include the tasks of the respective subordinate role. An RFD always requires an FFD as a communication partner and therefore can always undertake only the role of a terminal. In each network there is precisely one coordinator 1 and no, one or more alternative coordinators that in the event of failure of the coordinator undertake the latter's task. The FFDs and RFDs differ from each other in the manner in which they can be inserted into the various network topologies. Only FFDs can be inserted into a mesh network. RFDs always adopt, as already mentioned, a terminal position in the network topology. RFDs are usually designed for a special task and therefore can be more cost effective and energy saving than FFDs. When one of the devices 2 to 6, also referred to here as network subscribers, logs onto a network, an identifier, by means of which the network subscriber can then be addressed, is assigned to it by the network coordinator 1.

As schematically shown in FIG. 2, the protocol stack for IEEE 802.15.4/ZigBee consists of the following units:

The bottom layers of the protocol stack consisting of the bit transmission layer (physical layer—PHY layer) and the medium access control layer (MAC layer) are contained in a separate hardware subsystem (MAC subsystem). The network layer and all the layers located above it are realized in a further hardware subsystem (host subsystem).

An interoperability layer 10 is inserted between the lower protocol layers in the MAC subsystem and the upper protocol layers in the host subsystem. As part of the interoperability layer 10, a transport layer establishes a logical connection between both hardware subsystems and is therefore distributed to both hardware subsystems. A transport protocol, which in addition to the transport of service primitives also determines the processing of general mechanisms such as flow control, is defined for the transport layer. The transport layer is itself based on a MAC hardware interface with a protocol (MAC-HW protocol) also generally being defined for the MAC hardware.

At the host subsystem end, the higher layers stack #1, stack #n of various protocol stacks e.g. ZigBee, DUST etc., lie above the transport layer, with the specific implementation of the respective service interfaces being matched to a uniform service interface of the transport layer by means of adapters.

At the MAC subsystem end, the lower layers, e.g. according to IEEE 102.15.4, of the various protocol stacks lie under (over in the illustration) the transport layer.

1.-6. (canceled)

7. A network for wireless transmission of data, wherein a mode of operation of the network is determined by a protocol stack according to a OSI reference model, wherein an interoperability layer is inserted into the protocol stack between a security layer following a bit transmission layer and other protocol layers based thereon, wherein the other protocol layers are based in parallel individual stacks on the interoperability layer.

8. The network for wireless transmission of data as claimed in claim 7, wherein the bit transmission layer and the security layer of the protocol stack are defined by the IEEE 802.15.4 standard and one of the individual stacks by the ZigBee standard.

9. The network for wireless transmission of data as claimed in claim 7, wherein the bit transmission layer and the security layer are realized on a first hardware system and the other protocol layers are realized on a second hardware system, the interoperability layer being distributed to both hardware systems and both hardware systems being connected to each other by a standard hardware interface.

10. The network for wireless transmission of data as claimed in claim 8, wherein the bit transmission layer and the security layer are realized on a first hardware system and the other protocol layers are realized on a second hardware system, the interoperability layer being distributed to both hardware systems and both hardware systems being connected to each other by a standard hardware interface.

11. The network for wireless transmission of data as claimed in claim 9, wherein the interoperability layer has a transport layer distributed to both hardware systems, the transport layer being connected to both hardware systems by interface drivers via hardware interfaces.

12. The network for wireless transmission of data as claimed in claim 10, wherein the interoperability layer has a transport layer distributed to both hardware systems, the transport layer being connected to both hardware systems by interface drivers via hardware interfaces.

13. A network subscriber for a network for wireless transmission of data, wherein a mode of operation of the network is determined by a protocol stack according to a OSI reference model, wherein an interoperability layer is inserted into the protocol stack between a security layer following a bit transmission layer and other protocol layers based thereon, wherein the other protocol layers are based in parallel individual stacks on the interoperability layer.

14. The network subscriber as claimed in claim 13, wherein the bit transmission layer and the security layer of the protocol stack are defined by the IEEE 802.15.4 standard and one of the individual stacks by the ZigBee standard.

15. A method for a wireless transmission of data in a network, wherein a mode of operation of the network is determined by a protocol stack according to a OSI reference model, wherein an interoperability layer is inserted into the protocol stack between a security layer following a bit transmission layer and other protocol layers based thereon, wherein the other protocol layers are based in parallel individual stacks on the interoperability layer.

16. The method for wireless transmission of data as claimed in claim 15, wherein the bit transmission layer and the security layer of the protocol stack are defined by the IEEE 802.15.4 standard and one of the individual stacks by the ZigBee standard.
